(19) United States
(12) Patent Application Publication
(10) Pub. No.: US 2015/0231539 A1
(43) Pub. Date: Aug. 20, 2015

(54) Filter System and Filter Element having a Coupling Device and Locking Device

(71) Applicant: MANN+HUMMEL GMBH, Ludwigsburg (DE)

(72) Inventors: Robert Hasenfratz, Waiblingen (DE); Fabian Wagner, Moeglingen (DE); André Roesgen, Remshalden (DE); Christian Thalmann, Speyer (DE); Frank Pflueger, Sachsenheim (DE); Petra Skorpíková, Nasimerice (CZ)

(21) Appl. No.: 14/623,663

(22) Filed: Feb. 17, 2015

(30) Foreign Application Priority Data
Feb. 20, 2014 (DE) 102014002241.2

(51) Int. Cl. B01D 35/00

(52) U.S. Cl. CPC B01D 35/005

(57) ABSTRACT

A fluid filter system has a filter element disposed in a filter housing with cover. A coupling device is provided with coupling element and corresponding coupling receptacle. The coupling device has a locking position and a release position. The coupling element engages the coupling receptacle in the locking position. The coupling element is released from the coupling receptacle in the release position. In the locking position, filter element and cover are coupled to each other. A locking device is provided with locking element and corresponding locking receptacle. The coupling device is moveable from the release position into the locking position by rotating the coupling element relative to the coupling receptacle about an axial direction and is releasable by rotating the coupling element relative to the coupling receptacle about the axial direction. The locking element locks the coupling device in the locking position by engaging the locking receptacle.

### BACKGROUND OF THE INVENTION

The invention concerns a filter system for filtering a fluid, comprising a coupling device and a locking device between a filter element and a cover, in particular for use as an oil filter or fuel filter of an internal combustion engine, as well as a filter element for installation in such a filter system.

In upright oil filters, the filter element is often to be removed with the filter cover upon unscrewing the filter cover. For this purpose, the filter element is usually attached by snap hooks to the filter cover.

EP 2 070 575 A1 discloses a liquid filter comprising a filter housing with a first thread and a drainage passage. Onto this liquid filter a filter cover with a second thread is screwed. First bayonet connections are provided on the filter cover. Second bayonet connections for attachment of the filter element on the filter cover are provided on the filter element. The first and second bayonet connections are matched to each other in such a way that the filter element can be inserted into the cover so that the first bayonet connections lock with the second bayonet connections. The bayonet connections are designed such that they detach together with the filter element, attached by means of the bayonet connections in the filter cover, when screwing on the filter cover. For detachability of the bayonet connections, they must be moveable more easily than the friction connection provided by a double-concentric seal for closing off the drainage passage which is provided on the filter element. Due to the rotation, the first bayonet connections of the filter cover then slide out of the second bayonet connections of the filter element and, upon further rotation, impact on the second bayonet connections without connecting again in doing so. The filter element is therefore decoupled from the filter cover after having been screwed in.

### SUMMARY OF THE INVENTION

It is an object of the invention to provide a filter system for filtering a fluid that enables, in a constructively simple and flexible way without additional tools, to remove a filter element from the filter system.

A further object of the invention is to provide a filter element for installation in such a filter system that can be removed from the filter system in a constructively simple and flexible way without additional tools.

The aforementioned objects are solved according to one aspect of the invention by a filter system that comprises a filter element, a filter housing with a cover, a coupling device for coupling the filter element with the cover, comprising a coupling element and a coupling receptacle, as well as a locking device comprised of at least one locking element and at least one locking receptacle. In this context, the coupling device comprises at least one locking position and at least one release position. Further, the objects are solved by a filter element for installation in such a filter system that comprises a coupling part and at least one locking part.

Beneficial configurations and advantages of the invention result from the further claims, the description, and the drawing.

A filter system for filtering a fluid is proposed comprising a filter element, a filter housing with a cover, a coupling device, comprised of at least two coupling parts for coupling the filter element with the cover, wherein the coupling parts comprise a coupling element and a corresponding coupling receptacle, as well as a locking device, comprised of at least two locking parts, wherein the locking parts comprise at least one locking element as well as at least one locking receptacle. In this context, the coupling device comprises at least one locking position and at least one release position. Furthermore, the coupling device is moveable from a release position into a locking position or is releasable by rotation of the coupling element relative to the coupling receptacle about an axial direction, wherein the at least one locking element locks the coupling device in the locking position in the at least one corresponding locking receptacle.

In particular, cover and filter element are embodied by means of the coupling device for common removal. Advantageously, the securing force of the coupling can be varied in this context by rotation of the coupling elements relative to each other about an axis of rotation. Particularly advantageously, in this way removal forces that are changeable about the rotation axis can be achieved in order to e.g. remove the filter element.

The filter system according to the invention, which preferably can be used as an upright filter system on an internal combustion engine, has a filter element that comprises a coupling device on its upper end face at an upper end disk which, for example, is embodied in the form of a coupling of a cloverleaf type. The coupling device has relative to the diameter of the filter element minimal dimensions. The coupling receptacle is, for example, arranged on the end disk of the filter element and the coupling element on the cover. Alternatively, a reverse arrangement is also conceivable.

The coupling receptacle is in the form of a ball flattened in axial direction or an ellipsoid with the shorter axis extending in the axial direction, wherein the coupling receptacle is configured to be rotation-symmetrical about the axial direction and is divided into individual coupling segments with undercut.

The coupling element can be, for example, embodied in the form of individual coupling jaws for insertion into the coupling receptacle which can surround the coupling receptacle on the exterior. The coupling jaws can glide between the coupling segments and, by rotation of the coupling element relative to the coupling receptacle, can engage below the coupling segments. The coupling jaws each comprise coupling hooks by means of which the coupling jaws can engage below the coupling segments. In doing so, with increasing engagement below the coupling segments, the coupling jaws are experiencing a progressive force, due to the shape of the coupling receptacle with, for example, spherical cross-section, so that the coupling element is thereby fixedly connected with the coupling receptacle.

At the same time, radially outwardly projecting locking elements that are also provided at the end disk of the filter element engage locking receptacles that are provided on the exterior rim of the cover and, for example, can be provided with an insertion ramp. With progressing rotation of the cover with the coupling element and engagement of the coupling jaws below the coupling segments, the locking elements glide into the locking receptacles because of the insertion ramps until they lock the coupling device in the locking position. Upon further rotation or reverse rotation of the cover relative to the filter element and thus relative to the coupling receptacle, the coupling device can be moved again out of the locking position into the release position. After overcoming a certain force in axial direction, the coupling jaws glide out of the position below the coupling segments with increasing force, the cover thereby is lifted slightly, and the locking elements can glide out of their locking receptacle via the insertion ramp.

In the locking position, the filter element can be pulled out by means of the cover from its receptacle in the filter housing, wherein in this connection also the force for opening a drainage passage at the bottom of the filter housing can be applied. With the coupling device according to the invention it is thus possible to apply forces in the magnitude of 50 to 80 N in axial direction.

The cover of the filter system can be produced usually of a polymer, for example, a thermoplastic material, but conceivable is also the manufacture from a metallic material. The coupling device itself can be produced from the same material as the cover and/or the material of the end disk of the filter element, for example, polyurethane.

In an advantageous embodiment, the coupling receptacle can be divided axially into coupling segments, wherein the coupling element comprises axially oriented coupling jaws which can engage between the coupling segments of the coupling receptacle. In this way, the coupling receptacle can be locked and released again relative to the coupling element in the form of a snap connection that has, for example, a cloverleaf-type shape.

Advantageously, the coupling device can experience a progressive force in axial direction upon rotation from a release position into a locking position. In this way, the coupling device can generate a fixed connection between the coupling receptacle and the coupling element and secure the coupling device in a locking position.

Expediently, the coupling receptacle can have a spherical cross-section. By means of this shape, the coupling jaws automatically experience a progressive force upon engagement below the coupling segments of the coupling receptacle and can thus lock the coupling device in a locking position.

In an alternative configuration, the coupling receptacle can have an ellipsoid-shaped cross-section wherein a shorter axis of the ellipsoid is oriented in axial direction. With this shape, the coupling jaws also automatically experience a progressive force upon engagement below the coupling segments of the coupling receptacle and can thus lock the coupling device in a locking position. The increase of the force with increasing rotation of the coupling element relative to the coupling receptacle is in this context smaller than in case of a spherical configurations so that less force must be applied for closing the coupling device.

Expediently, the coupling receptacle and the one or several locking elements can be arranged on the filter element and the coupling element and the one or several locking receptacles on the cover. Such a configuration is beneficial for mounting and demounting of the cover on the filter system. Alternatively, a reverse arrangement of coupling receptacle and coupling element as well as of locking element and locking receptacle is conceivable in principle.

Advantageously, the coupling device can be arranged center-symmetrical in the filter system. In this way, a beneficial force distribution upon pulling out the filter element from the filter housing via the cover is provided. Also, the risk of tilting of the filter element is minimal in this context.

Expediently, the coupling part arranged on the filter element can have a bore for venting the filter system. Especially in upright operation of the filter system, the bore, which is preferably arranged in axial direction of the coupling part on the filter element, constitutes a very effective venting bore. In this way, only very little air remains within the filter system because the air can escape via the highest point of the filter system.

Advantageously, a bypass valve can be provided in the filter system whereby drainage of the fluid out of the filter system can be effected by means of the bore of the coupling part when opening the cover. Upright filter systems have usually a sealing seat with a drain into a tank system or a reservoir must be pulled open when which pulling out the filter element. By introducing the air via the bore provided in the coupling part, the filter system can thus be effectively emptied for exchanging the filter element.

According to a further aspect, the invention concerns the use of the filter system as an oil filter or fuel filter, in particular of an internal combustion engine. In these fluid filters, usually an exchange of the filter element after a predetermined service life is required so that the filter system must be opened in regular intervals and the filter element removed as well as a new filter element inserted, which is possible in an advantageous way with the coupling device according to the invention.

According to a further aspect, the invention concerns a filter element for installation in the above-described filter system, comprising an end disk with a coupling part of the coupling device arranged thereat and provided for interaction with a corresponding coupling part of the coupling device as well as a locking element of a locking device provided thereat and provided for interaction with the corresponding locking part of the locking device.

In an advantageous embodiment, the coupling parts in this context can comprise a coupling element and a corresponding coupling receptacle. The coupling device is moveable from a release position into a locking position or is releasable by rotation of the coupling element relative to the coupling receptacle about an axial direction. Moreover, the locking device can comprise at least one locking element and at least one corresponding locking receptacle, wherein the at least one locking element locks the coupling device in the locking position by engaging the at least one corresponding locking receptacle.

In a locking position in the filter system, the filter element can be pulled out by means of the cover of the filter system from the receptacle in the filter housing, wherein in this context also the force for opening a drainage passage at the bottom of the filter housing can be applied. By means of the coupling device according to the invention, forces in the magnitude of 50 to 80 N can be applied in this way in axial direction onto the filter element.

### BRIEF DESCRIPTION OF THE DRAWINGS

Further advantages result from the following drawing description. In the drawings, embodiments of the invention are illustrated. The drawings, the description, and the claims contain numerous features in combination. A person of skill in the art will consider the features also expediently individually and combine them to meaningful other combinations.

FIG. 1 shows a schematic longitudinal section illustration of a filter system with attached cover according to an embodiment of the invention.

FIG. 2 shows a schematic cross-sectional illustration of a filter system in a locking position according to an embodiment of the invention.

FIG. 3 shows a cover of a filter system according to an embodiment of the invention.

FIG. 4 shows a filter element with focus on the coupling device according to an embodiment of the invention.

FIG. 5 shows a cross-section (section line V-V in FIG. 6) of a filter system in a release position according to an embodiment of the invention.

FIG. 6 is a perspective view of a filter system in a release position according to an embodiment of the invention.

FIG. 7 shows a cover of a filter system according to another embodiment of the invention.

FIG. 8 shows a filter element according to another embodiment of the invention with coupling parts and locking parts.

FIG. 9 is a longitudinal section of a filter element according to an another embodiment of the invention with attached cover of the filter system.

### DESCRIPTION OF PREFERRED EMBODIMENTS

In the Figures same or similar components are identified with same reference characters. The Figures show only examples and are not to be understood as being limiting.

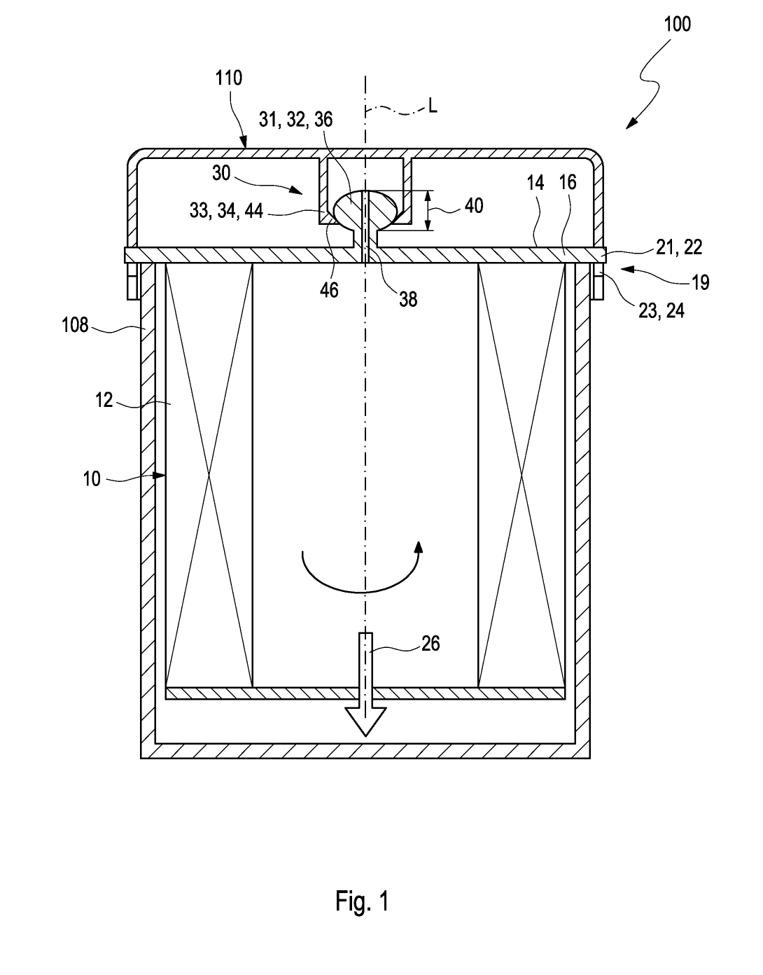

FIG. 1 shows a schematic longitudinal section illustration of a filter system 100 with attached cover 110 according to an embodiment of the invention. The filter system 100 for filtering a fluid comprises a filter element 10, a filter housing 108 with a cover 110, as well as a coupling device 30 for coupling the filter element with the cover 110, comprising a coupling part in the form of a coupling receptacle 36, a coupling part in the form of a coupling element 34, and a locking device comprising at least one locking element 22 as well as at least one locking receptacle 24. In this context, the coupling device 30 comprises at least one locking position 18 and at least one release position 20. Moreover, the coupling device 30 is moveable from a release position 20 into a locking position 18 or is releasable by rotation of the coupling element 34 relative to the coupling receptacle 36 about an axial direction L, wherein the at least one locking element 22 locks the coupling device 30 in the locking position 18 by engaging the at least one corresponding locking receptacle 24.

The filter system 100 according to the invention, which can be used preferably as an upright filter system 100 on an internal combustion engine, comprises a filter element 10 that, at its upper end face 14 on an upper end disk 16, comprises a coupling part of a coupling device 30 which, for example, is embodied in the form of a cloverleaf-shaped coupling. The coupling device 30 has relative to the diameter of the filter element minimal dimensions. The coupling receptacle 36 of the coupling device 30 is arranged, for example, on the end disk 16 of the filter element 10 and the coupling element 34 of the coupling device 30 on the cover 110. Alternatively, a reverse arrangement is also conceivable.

The coupling receptacle 36 is in the form of a sphere flattened in axial direction L or an ellipsoid having a long axis and a short axis, with the short axis 40 extending in axial direction L. The coupling receptacle 36 is designed with rotational symmetry about the axial direction L and is divided into individual coupling segments 32 in undercut configuration.

The coupling element 34 can be, for example, in the form of individual coupling jaws 44 for receiving the coupling receptacle 36 and can engage the coupling receptacle 36 from the exterior. The coupling jaws 44 can glide between the coupling segments 32 and, by rotation of the coupling element 34 relative to the coupling receptacle 36, can engage below the coupling segments 32. The coupling jaws 44 each have coupling hooks 46 by means of which the coupling jaws 44 engage below the coupling segments 32. In this connection, the coupling jaws 44 experience a progressive force with increasing engagement below the coupling segments 32 due to the shape of the coupling receptacle 36 with, for example, spherical cross-section, so that the coupling element 34 is therefore fixedly connected in this way with the coupling receptacle 36.

At the same time, radially outwardly projecting locking elements 22, also provided on the end disk 16 of the filter element 10, engage corresponding locking receptacles 24 provided on the outer rim of the cover 110 and, for example, embodied with an insertion ramp 25. With increasing rotation of the cover 110 with the coupling element 34 and engagement of the coupling jaws 44 below the coupling segments 32, the locking elements 22 glide by means of the insertion ramps 25 into the locking receptacles 24 until they lock the coupling device 30 in the locking position 18.

Upon further rotation or reverse rotation of the cover 110 relative to the filter element 10 and thus relative to the coupling receptacle 36, the coupling device 30 can be moved again out of the locking position 18 into a release position 20. After overcoming a certain force 26 in axial direction, the coupling jaws 44 glide again out of the position below the coupling segments 32 with decreasing force, the cover 110 lifts therefore slightly, and the locking elements 22 can glide out of their locking receptacle 24 via the insertion ramp 25.

In the locking position 18, the filter element 10 can be pulled out by means of the cover 110 from the receptacle in the filter housing 108, wherein in this context also the force for opening the drainage passage at the bottom of the filter housing 108 can be applied. With the coupling device 30 according to the invention, forces 26 in the magnitude of 50 to 80 N, for example, can be applied in axial direction L in this way.

The coupling receptacle 36 can have a spherical cross-section. Alternatively, it can also have an ellipsoid cross-section, wherein the short axis 40 of the ellipsoid is oriented in axial direction L.

In FIG. 1, it is also illustrated that the coupling receptacle 36 can have a bore 38 for venting the filter system 100. Particularly in upright operation of the filter system 100, a bore 38, which preferably is arranged in the axial direction L of the coupling receptacle 36, constitutes a very effective venting bore. In this way, only very little air remains within the filter system 100 because the air can escape via the highest point of the filter system 100.

Moreover, a bypass valve can be provided in the filter system 100 so that drainage of the fluid from the filter system 100 can be effected by means of the bore 38 of the coupling receptacle 36 when opening the cover 110. Upright filter systems have usually a sealing seat with a drain into a tank system or a reservoir which must be pulled open when pulling out the filter element 10. By inflow of the air via the bore 38 provided within the coupling receptacle 36, the filter system can thus be effectively emptied for exchanging the filter element 10.

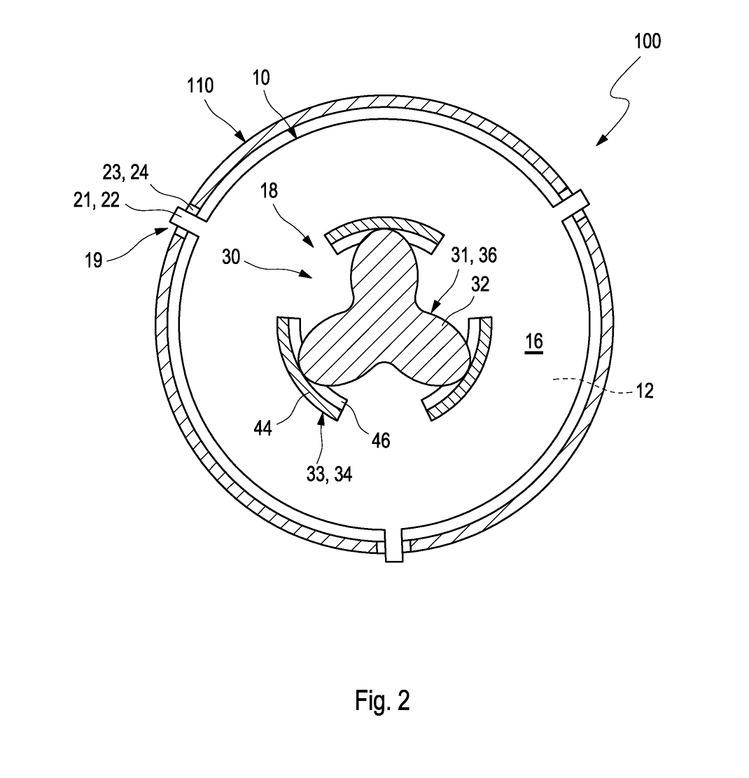

FIG. 2 shows a schematic cross-section illustration of a filter system 100 in a locking position 18 according to one embodiment of the invention. The coupling receptacle 36 is axially divided into coupling segments 32, wherein the coupling element 34 comprises axially oriented coupling jaws 44 which engage between the coupling segments 32 of the coupling receptacle 36 and, due to an undercut of the coupling receptacle 36, can glide below the coupling segments 32. In this way, the coupling device 30 upon rotation from a release position 20 into a locking position 18 experiences a progressive force in axial direction L. The coupling receptacle 36 and the one or several locking elements 22 are provided on the filter element 10, i.e., at the end disk 16, and the coupling element 34 and the one or several locking receptacles 24 on the cover 110. For reasons of symmetrical force distribution when pulling out the filter element 10 with the cover 110, the coupling device 30 is arranged center-symmetrical in the filter system 100.

In the locking position 18 illustrated in FIG. 2, the coupling jaws 44 are rotated into a position below the coupling segments 32 of the coupling receptacle 36 so that in this way the coupling device 30 is closed and the filter element 10 together with the cover 110 can be pulled out of the filter housing 108.

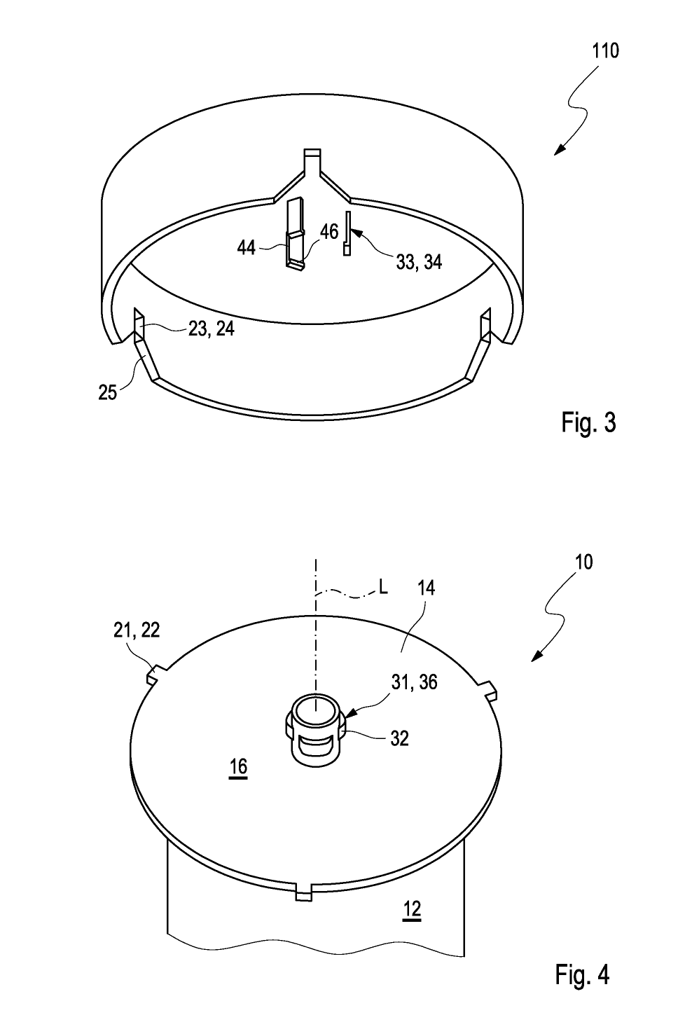

In FIG. 3, a cover 110 of the filter system 100 according to an embodiment of the invention is illustrated. The cover 110 comprises at its bottom side three coupling jaws 44 of a coupling element 34 while at its outer rim three locking receptacles 24 with appropriate insertion ramps 25 can be seen. The coupling jaws 44 have each coupling hooks 46 by means of which the coupling jaws 44 can engage below the coupling segments 32.

FIG. 4 shows a filter element 10 with focus on the coupling device 30 according to an embodiment of the invention. The filter body 12 comprises at its end face 14 an end disk 16 having arranged center-symmetrical at its center a coupling receptacle 36 with three coupling segments 32. Three radially outwardly projecting locking elements 22 are arranged on the outer rim of the end disk 16.

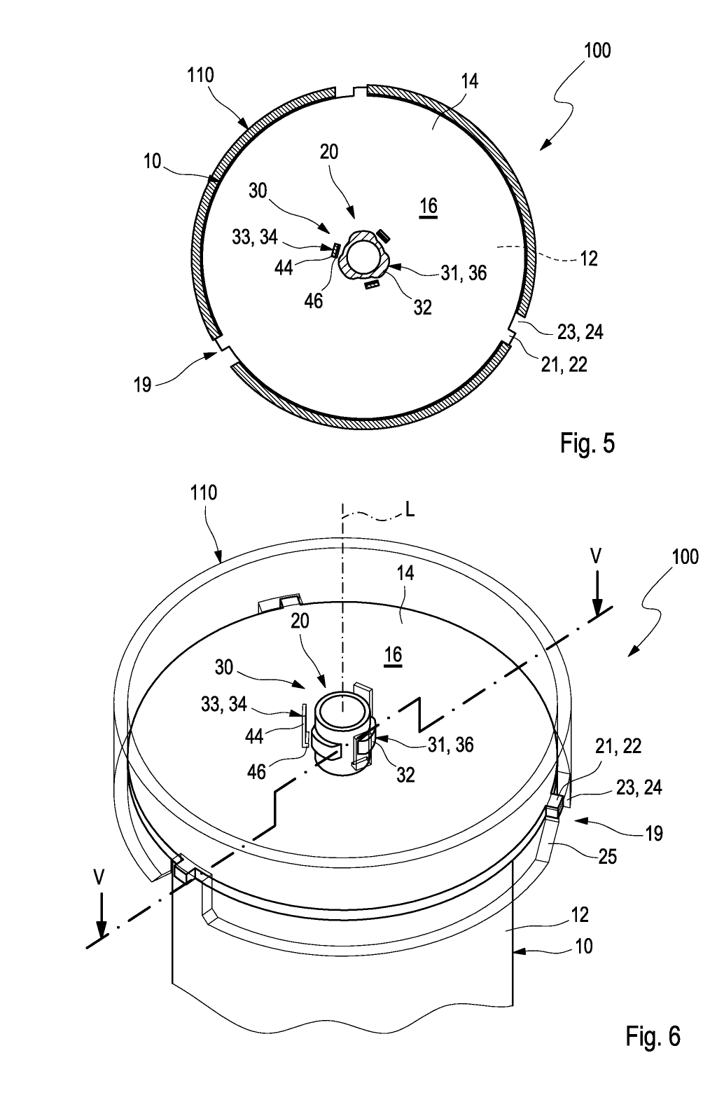

In FIG. 5, a cross-section of the filter system 100 in a release position 20 of the coupling device 30 according to an embodiment of the invention is illustrated. The cover 110 of the filter system 100 engages with the coupling jaws 44 between the coupling segments 32 of the coupling receptacle 36. In this way, the cover 110 can be pulled in upward direction off the filter element 10 in axial direction L. On the rim of the cover 110 three locking elements 22 are illustrated which engage corresponding locking receptacles 24.

FIG. 6 shows a perspective illustration of a filter system 100 in a release position 20 of the coupling device 30 according to an embodiment of the invention. For better understanding, the illustration shows the cover to be “transparent”. The cover 110 of the filter system 100 engages with the coupling jaws 44 between the coupling segments 32 of the coupling receptacle 36. In this way, the cover 110 can be pulled off the filter element 10 upwardly in axial direction L. On the rim of the cover 110, three locking elements 22 are illustrated which engage corresponding locking receptacles 24.

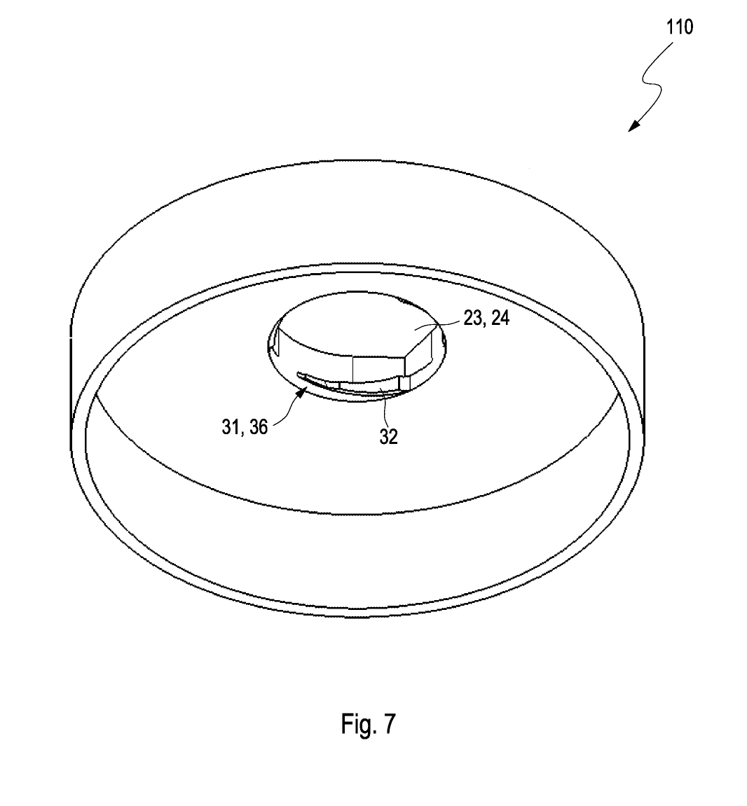

In FIG. 7, a cover 110 of a filter system 100 according to another embodiment of the invention is illustrated. In this embodiment, the coupling receptacle 36, as a coupling part 31 in the form of coupling segments 32 with an ascending ramp, is arranged in the form of a recess within the cover 110 while, in contrast to the preceding embodiments, a locking receptacle 24 as a locking part 23 in the form of a collar is arranged within the cover 110 in the recess.

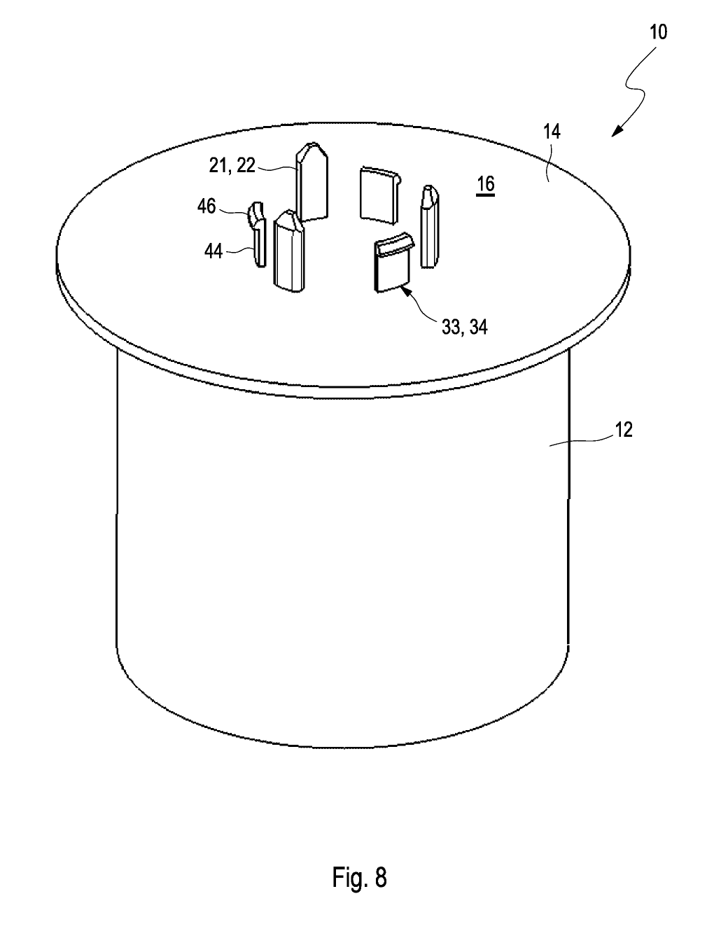

FIG. 8 shows a filter element 10 according to another embodiment of the invention with coupling part 33 and locking parts 21. In this embodiment, the coupling element 34 as coupling part 33, comprised of coupling jaws 44 with coupling hooks 46, is arranged centrally on the end disk 16 of the filter element 10. In contrast to the preceding embodiments, locking elements 22 as locking parts 21 are arranged, also centrally, in the inner area of the end disk 16.

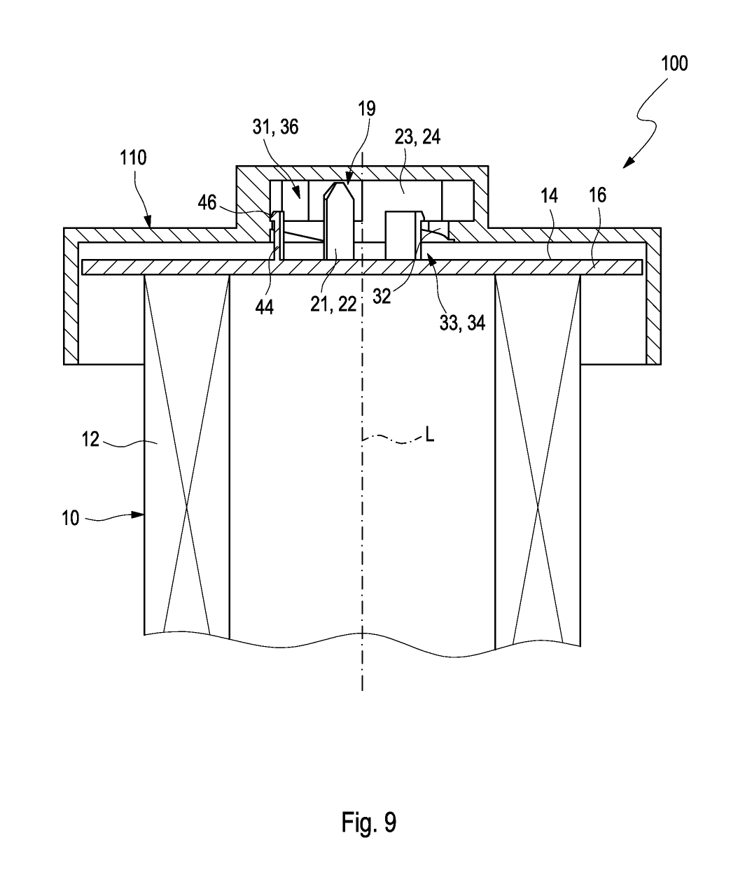

In FIG. 9, a longitudinal section through the filter element 10 according to another embodiment of the invention with attached cover 110 of the filter system 100 is illustrated. In this illustration, meshing of the coupling parts 31, 33 of the coupling device 30 as well as of the locking parts 21, 23 of the locking device 19 can be seen. When placing the cover 110 onto the filter element 10, the coupling jaws 44 glide between the coupling segments 32 of the coupling receptacle 36 and engage with their coupling hooks 46 the ramp-shaped coupling segments 32 that are designed as undercuts. With further rotation of the cover 110 relative to the filter element 10, the coupling hooks 46 are guided on the coupling segments 32. Due to the ramp shape, a progressive force is exerted onto the coupling hooks 46 with increasing rotation of the cover 110 relative to the filter element 10, and the unit of filter element 10 with cover 110 is thus pulled together. Accordingly, the locking elements 22 can snap into the locking receptacle 24 and, in this way, can lock the cover 110 relative to the filter element 10. For releasing the cover 110, the cover 110 can be rotated in the opposite direction so that, after overcoming a certain locking force, the locking elements 22 can unlock from their locking engagement in the locking receptacle 24 and the coupling element 34 with the coupling hooks 46 of the coupling jaws 44 can glide back across the ramp-shaped coupling segments 23. In this way, the cover 110 can be pulled off the filter element 10.

While specific embodiments of the invention have been shown and described in detail to illustrate the inventive principles, it will be understood that the invention may be embodied otherwise without departing from such principles.

What is claimed is:

1. A filter system for filtering a fluid, the filter system comprising:
a filter housing comprising a cover;
a filter element disposed in the filter housing;
a coupling device comprising at least two coupling parts, wherein the at least two coupling parts comprise a coupling element and a corresponding coupling receptacle;
wherein the coupling device comprises at least one locking position and at least one release position, wherein the coupling element engages the coupling receptacle in the at least one locking position and wherein the coupling element is disengaged from the coupling receptacle in the at least one release position, wherein in the at least one locking position the filter element and the cover are coupled to each other;
a locking device comprising at least two locking parts;
wherein the at least two locking parts comprise at least one locking element and at least one corresponding locking receptacle;
wherein the coupling device is configured to move from the at least one release position into the at least one locking position by rotating the coupling element relative to the coupling receptacle about an axial direction and is further configured to be released from the at least one locking position into the at least one release position by rotating the coupling element relative to the coupling receptacle about the axial direction;
wherein the at least one locking element locks the coupling device in the locking position by engaging the at least one locking receptacle.

2. The filter system according to claim 1, wherein the coupling receptacle is divided axially into coupling segments, wherein the coupling element comprises axially oriented coupling jaws engaging between the coupling segments of the coupling receptacle in the at least one release position.

3. The filter system according to claim 1, wherein the coupling device, when moved from the at least one release position into the at least one locking position, experiences a progressive force in the axial direction.

4. The filter system according to claim 1, wherein the coupling receptacle comprises a spherical cross-section.

5. The filter system according to claim 1, wherein the coupling receptacle comprises an ellipsoid cross-section comprising a short axis and a long axis, wherein the short axis is oriented in axial direction.

6. The filter system according to claim 1, wherein the coupling receptacle is arranged on the filter element and the coupling element is arranged on the cover.

7. The filter system according to claim 6, wherein the at least one locking element is arranged on the filter element and the at least one locking receptacle is arranged on the cover.

8. The filter system according to claim 6, wherein the at least one locking element is arranged on the cover element and the at least one locking receptacle is arranged on the filter element.

9. The filter system according to claim 1, wherein the coupling receptacle is arranged on the cover and the coupling element is arranged on the filter element.

10. The filter system according to claim 9, wherein the at least one locking element is arranged on the filter element and the at least one locking receptacle is arranged on the cover.

11. The filter system according to claim 9, wherein the at least one locking element is arranged on the cover and the at least one locking receptacle is arranged on the filter element.

12. The filter system according to claim 1, wherein the coupling device is arranged center-symmetrical in the filter system.

13. The filter system according to claim 1, wherein the coupling receptacle is arranged on the filter element and comprises a bore configured to vent the filter system.

14. The filter system according to claim 1 in the form of an oil filter or a fuel filter for an internal combustion engine.

15. A filter element of a filter system, the filter system comprising a filter housing that comprises a cover and is configured to receive the filter element, wherein the cover of the filter housing comprises a first coupling part of a coupling device and wherein the cover of the filter housing further comprises a first locking part of a locking device; the filter element comprising:
an end disk comprising a second coupling part of the coupling device, the second coupling part of the coupling device configured to interact with the first coupling part of the coupling device;
wherein the end disk further comprises a second locking part of the locking device that is configured to interact with the first locking part of the locking device.

16. The filter element according to claim 15, wherein the coupling device is configured to move from a release position into a locking position by rotating the first and second coupling parts relative to each other about an axial direction and is further configured to be released from the at least one locking position into the at least one release position by rotating the first and second coupling parts relative to each other about the axial direction, and wherein the first and second locking parts interact with each other to lock the coupling device in the locking position.

17. The filter element according to claim 16, wherein the first coupling part is a coupling receptacle and the second coupling part is a coupling element.

18. The filter element according to claim 17, wherein the first locking part is a locking element and the second locking part is a locking receptacle.

19. The filter system according to claim 17, wherein the first locking part is locking receptacle and the second locking part is a locking element.

20. The filter element according to claim 16, wherein the first coupling part is a coupling element and the second coupling part is a coupling receptacle.

21. The filter element according to claim 20, wherein the first locking part is a locking element and the second locking part is a locking receptacle.

22. The filter system according to claim 20, wherein the first locking part is locking receptacle and the second locking part is a locking element.
